(19) United States
(12) Patent Application Publication
(10) Pub. No.: US 2005/0238219 A1
(43) Pub. Date: Oct. 27, 2005

(54) Method for tomographic image reconstruction using an analytical process involving modeling of the movement of the object

(76) Inventors: Sebastien Roux, Granoble (FR); Anne Koenig, St Martin d'Uirage (FR); Laurent Desbat, Grenoble (FR); Pierre Grangeat, Saint Ismier (FR)

Correspondence Address: Thelen Reid & Priest, P O Box 640640, San Jose, CA, 95164-0640, US

(21) Appl. No.: 10/524,967

(22) PCT Filed: Jun. 28, 2004
(86) PCT No.: PCT/FR04/50295

§ 371 Date: Feb. 18, 2005

(30) Foreign Application Priority Data
Jun. 27, 2003 (FR) 03/07848

(51) Int. Cl. G06K 9/00

(52) U.S. Cl. 382/131; 382/154

(57) ABSTRACT

A correct inversion formula of projections of tomography is proposed by supposing improved deformation of the object (E), that is, comprising translations, rotations and homotheties comparable to uniform dilations. Generalisations to other deformation situations of the object in question and other radiations are possible.

The object of this invention is a process for reconstruction of a tomographic image, of the analytical type, and in which improved modelling of the movement of the object is resorted to so as to reduce the artefacts of the image.

The reconstruction of images in tomography implies the utilisation of radiation passing through the object. In numerous cases, the radiation is irradiation radiation partially attenuated by the points of the object it passes through; it also happens that the radiation lines are artificial and correspond simply to collimation lines of the detectors, which register an emission of particles in the object. The first of these processes are radiography processes, and the others are emissive processes, reserved more for living beings and in which the radiation is produced by an emissive body previously absorbed. Although the two families of processes are completely different, the majority of the processes for reconstruction of images apply to both, and this is also the case with the invention.

Divergent radiation is often preferred for more easily enclosing the object studied. In the case of irradiation radiation attenuated by the object, this is achieved by having a source emissive at a punctiform focal point near the object and a network of detectors on the opposite side of the object, all of which are collimated towards the source; in the case of radiation emitted by the object, a similar network of detectors is collimated to a un focal point which corresponds geometrically to the preceding punctiform source, but to any material object. In all cases, the focal point and the network of detectors are moved about the object by taking successive views thereof, and for each of the views, the detectors measure totals of the attenuation or emission property along collimation lines, known as projections of the image of the object. When a sufficient number of views has been taken, there is a large number of projections crisscrossing through the object. The mathematical problem known as system inversion provides the attenuation or emission property which serves to form the image at each of the points of the object from sums of properties on the projections. It can be represented by a linear system of equations where the values known at the outset are the measurements taken by the detectors at different locations and the unknown ones are the values of the property at different points of the object. Certain methods of reconstruction known as algebraic effectively resort to inversion of this system; yet there are other methods known as analytical, where the value of the property at each point is calculated directly from a mathematical combination of the projections. The present invention is one such.

An important domain of tomography is the study of living beings for medicine. As several successive views must be taken, the object in question is capable of moving between them according to a general law of evolution. The different views thus represent different states of the object, and artefacts of reconstruction can appear only on the reconstructed image.

Processes for avoiding this permanent problem consist of taking all the views at once with as many sources and networks of detectors, or taking views of the object only in states identical to the latter, which is possible if its movement is periodical as are certain physiological activities such as heartbeat or breathing; the first of these processes is however expensive and the second is delicate to implement conveniently.

This is also why numerical models of the movement of the object reflecting the general law of evolution of the object were incorporated in the process of reconstruction. The model generally goes back to a collection of shift fields of the points of the object at respective times where the views are taken. This can be established by other measures or by certain hypotheses. Several genres of models have already been put forward, but they are generally insufficient. U.S. Pat. No. 5,287,276, applied to the study of the thoracic cage, considered translations and dilations of its content, but this model is insufficient for other movements, such as that of the heart, which comprises torsion. In addition, the sets of projections utilised to apply the inversion formula are not very well known, which can allow new artefacts.

The process of the invention offers the advantage of using a more elaborate but also very simple model of the movement of the object, comprising new classes of movements, and returning to a new and perfectly exact inversion formula.

In addition, it is easy to obtain the sets of projections necessary and only necessary for reconstruction of the points of the image.

Generalisations to more complex situations are also proposed.

In its general form the invention concerns a process for reconstruction of a tomographic image of an especially mobile and deformable object, the image being a set of values of a property taken by points of the object, comprising the use of: divergent radiation from a focal point and passing through the object, the focal point being mobile about the object; an analytical model of mobility and deformation of the object defined for each position of the focal point; and an analytical calculation process for obtaining said values from totals of the values of the property along projection lines leading to the focal point and passing respectively by the points; characterised in that the model is improved, and is a variable combination being acquired, this combination comprising translations, rotations and homotheties of the object from an origin, and in that the process of analytical calculation comprises the following stages:
weighting of the measurements, this weighting being dependent on the analytical model of mobility and deformation of the object;
derivation of the measurements weighted following the trajectory of the focal point considering a direction adapted to the model, this direction being kept constant, and obtaining modified measurements;
retroprojection of the modified measurements.

Prior to weighting, filtering of the measurements acquired by a Hilbert filter is often applied, since it is usual in other processes. The weighting and derivation then apply to the filtered measurements.

The following figures are introduced to explain the invention:

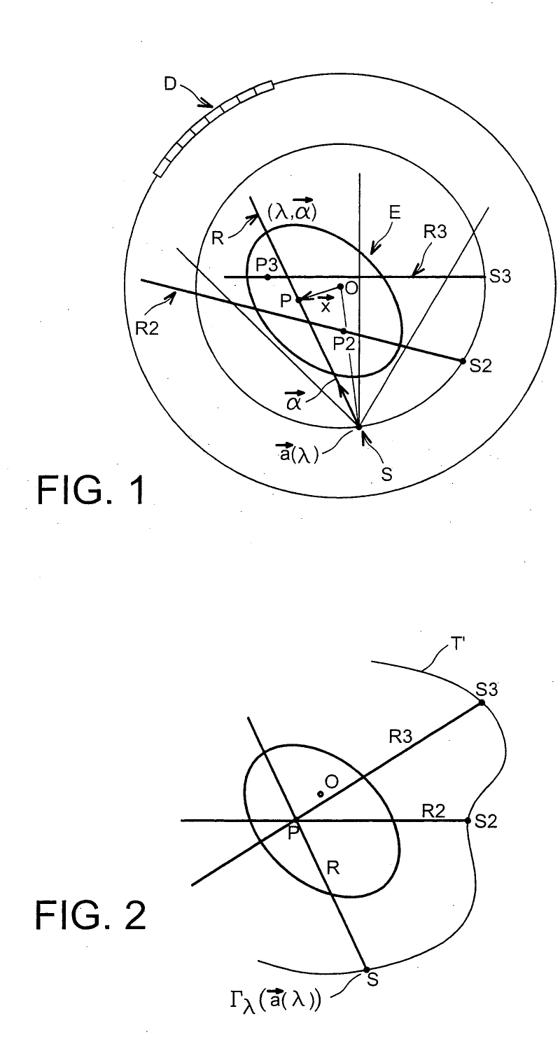

FIG. 1 illustrates taking the measurements of the object in question,

FIG. 2 illustrates an equivalent diagram, the object being maintained in a state of reference,

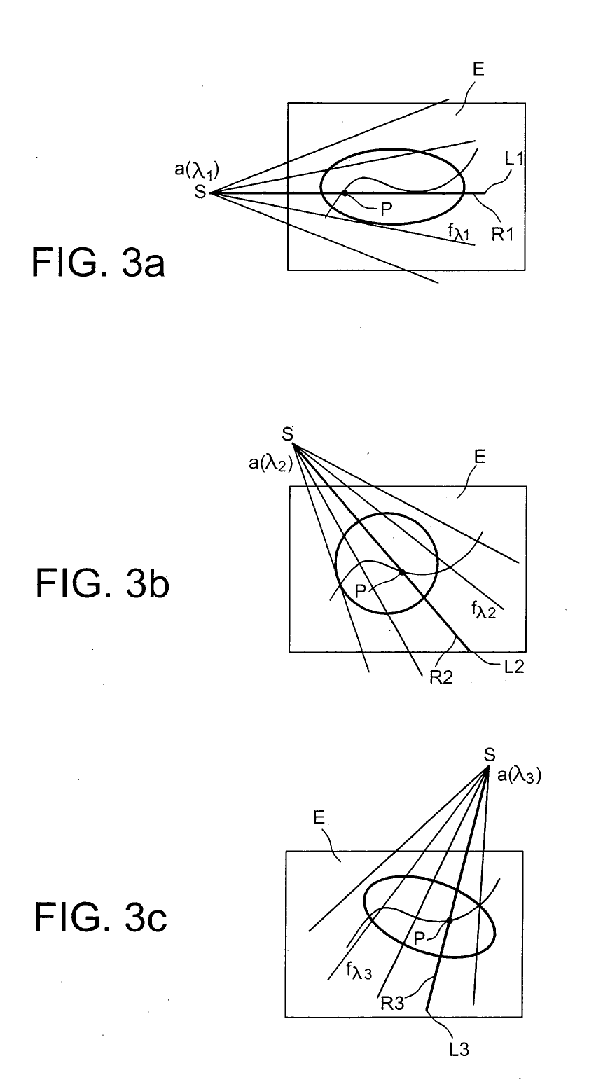

FIGS. 3a, 3b and 3c illustrate a complex case of deformation of the object,

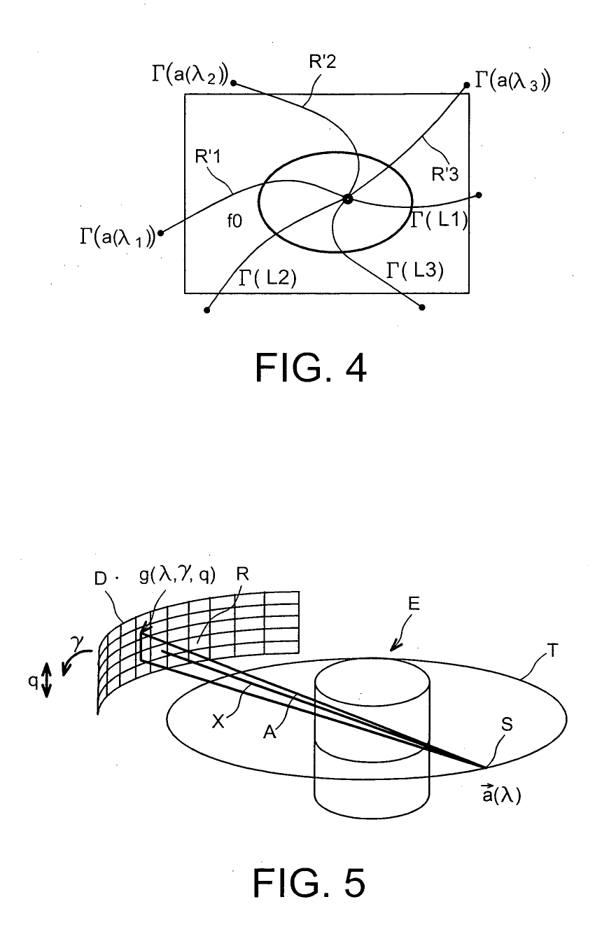

FIG. 4 is similar to FIG. 2 in the complex case,

FIG. 5 illustrates taking measurements with conical radiation, and

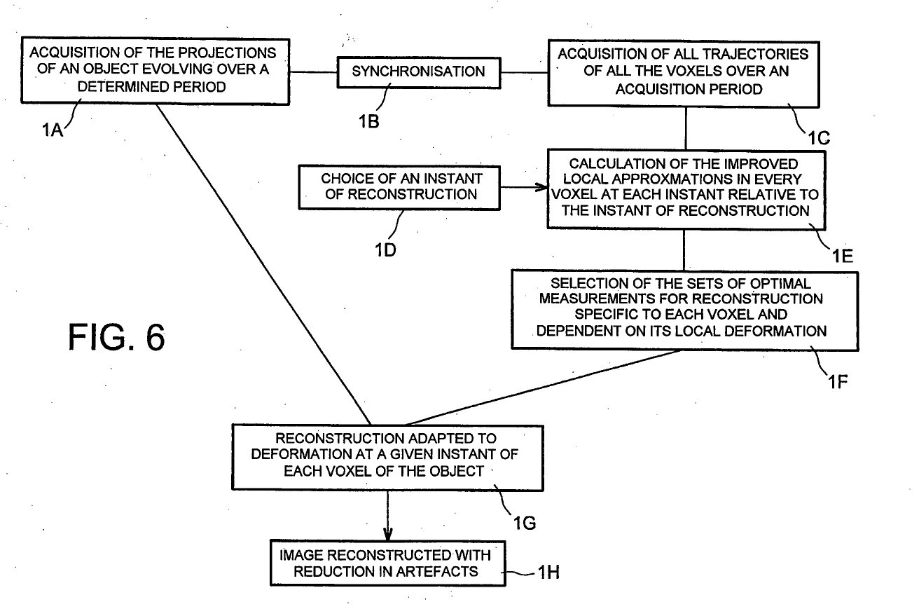

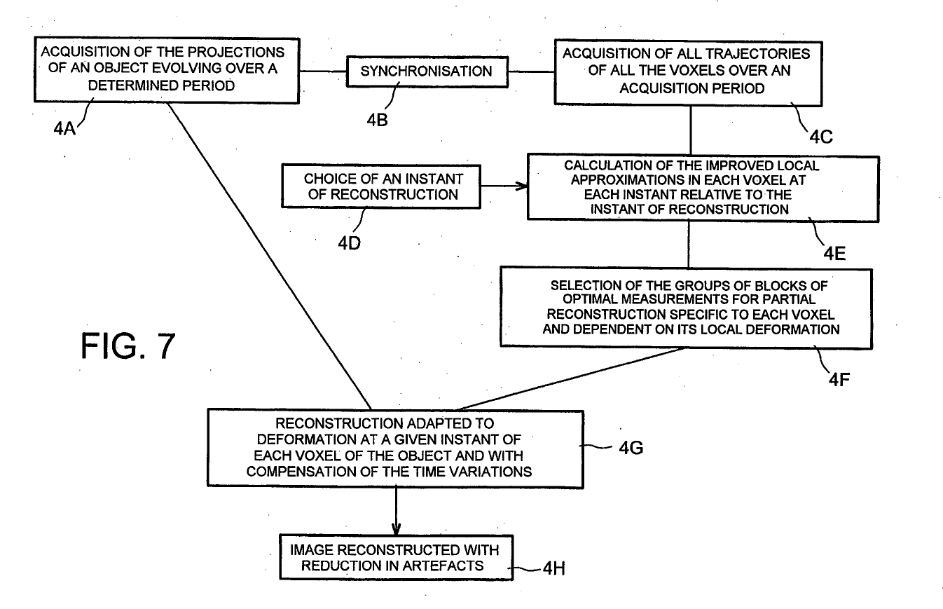

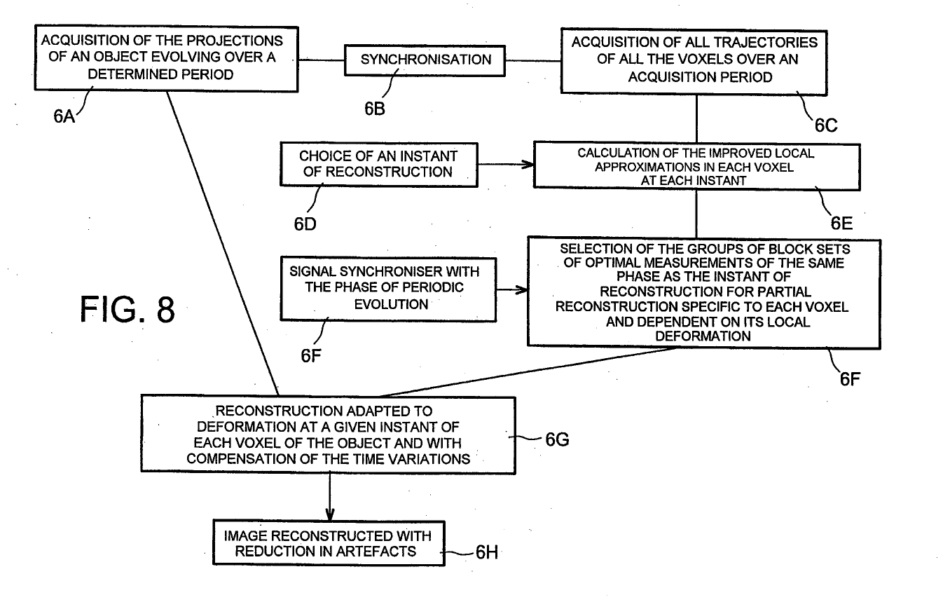

FIGS. 6, 7 and 8 are organigrams of three embodiments of the invention.

Reference is now made to the figures. The first of them illustrates the classic situation in tomography of a source S of radiation and a tuned mobile network of detectors D on circular trajectories concentric to opposite positions around an object E to be studied. Radii R join the source S to the respective detectors of the network D. Under consideration here is a problem of geometric plan, which corresponds to the so-called fan-shaped parallel measurement conditions, where study of the object E is made by superposed slices s. The processes implying conical radiation are also common and will be examined hereinbelow. The invention was designed to divergent radiation in general, which include the latter also.

The trajectory T of the source S and opening of the radiation bundle are generally selected such that the latter includes the whole section of the object.

We should consider a point P of the object E. A sole radius originating from the source S passes through it when a view is taken, and other radii R2, R3, etc. likewise pass through it for other positions S2, S3, etc. from the source S when other views are taken. These beams passing through the point P are utilised to determine the image of the point P in the inversion process. It is useful that the radii being considered are oriented in directions as varied as possible, so as to describe all the straight directions possible for each point of the object E.

It should now be considered that the object E is moved and deformed. The point P moves inside the trajectory T and the radii R2, R3, etc. to be employed pass through respective positions P2, P3, etc. distinct from the point origin P. The problem of reconstruction to be resolved is identical to the artificial configuration of FIG. 2, or the point P was taken as immobile reference and where everything happens as if the source S followed a trajectory T′ having an irregular form and to the numerical definition noted by \vec{OS}=Γ_{λ}(\vec{α}(λ)) (and \vec{α}(λ) in the real configuration of FIG. 1). It is obvious that this artificial diagram of the problem aids in its comprehension. According to the invention, the model of displacement and deformation selected for the object E is improved, composed for example from a variable combination over the course of acquisition of translations, rotations and homotheties, according to the formula (1)

$${{x}^{->}}_{0} = {Γ}_{λ} ( {x}^{->} ) = {A}_{λ} {x}^{->} + {B}_{λ} = [ \frac{{a}_{11} ( λ ) {a}_{12} ( λ )}{{a}_{21} ( λ ) {a}_{22} ( λ )} ] {x}^{->} + [ \frac{{b}_{1} ( λ )}{{b}_{2} ( λ )} ] \qquad ( 1 )$$

where \vec{x}₀ is the vectorial position of the point P relative to a reference such as the point O at the reference instant selected to carry out the calculations and reconstruction of the image, \vec{x} is the position of the point 2 at another instant and especially a view-taking instant, and the coefficients a and b dependent on the time. λ is a general parameter of the process, which varies between a minimal value λ min and maximal value λ max; the time is fixed by a monotone function de λ, (optionally by λ itself). The reference instant where the image is reconstructed corresponds to λ=0. The attenuation or emission property to be calculated is noted f, and for the point P fixed by the vector \vec{x} it is noted fλ(\vec{x}) at any λ instant and f₀(\vec{x}₀) at the reference instant, where \vec{x} is noted as \vec{x₀}.

The value of projection of the property measured over the entire radius R going from the source to a detector of the network D via the object E is given by the formula (2), where \vec{α} is a unitary vector, and this projection is noted as a function of this unitary vector \vec{α} and of the parameter λ:
g_{λ}(λ,\vec{α})=∫_{R}dtf_{λ}(\vec{α}(λ)+t\vec{α}) (2)
where t is a parameter expressing the progression of the projection on the radius and taking the values included in the set of positive real numbers R.

It is usual to apply a Hilbert filter to the projections in analytical methods, which is done here also, and the filtered projections are noted gHλ according to the formula (3)

$${g}_{H λ} ( λ , {n}^{->} ) = - {\int }_{{S}^{1}} ⅆ {α}^{->} {h}_{H} ( {n}^{->} \cdot {α}^{->} ) {g}_{λ} ( λ , {α}^{->} ) , \qquad ( 3 )$$

Where \vec{n} is any vector, S¹ is the sphere unit in bidimensional, h_{H} is indicated by the formula (4)

$${h}_{H} ( s ) = - {\int }_{- ∞}^{+ ∞} ⅆ σⅈ sign ( σ ) {ⅇ}^{2 ⅈ πσ s} . \qquad ( 4 )$$

To create the formulas the specialist could use either a classic operation of discrete convolation which will introduce a discrete version of the Hilbert filter, or a multiplication operation in the domain of Fourier, which will introduce an apodised version of the Fourier transform of the Hilbert filter.

The inventors have also established the following equation (5)

$${g}_{H λ} ( λ , {A}_{λ}^{T} {n}^{->} ) = \frac{1}{\vert det {A}_{λ} \vert} {P}_{oH} ( {n}^{->} \cdot {Γ}_{λ} ( {a}^{->} ( λ ) ) ) , \qquad ( 5 )$$

where the matrix-vector product A_{β}^{T}\vec{n} is the direction orthogonal to the projection straight line at the instant λ passing through the mobile point corresponding to the point P, \vec{n} is still any vector and or P_{OH} designates parallel projections P_{OH} (\vec{n}, s), obtained by rearranging the projections effectively measured on the object in the reference state and filtered by the Hilbert filter according to the following formula (6)
   P_{oH}(\vec{n},s)=∫_{R}ds′Pₒ(\vec{n},s′)h_{H}(s−s′)
s being a parameter giving the distance at the origin.
The inversion formula carried out is thus the following formula (7)

$${f}_{o} ( {{x}^{->}}_{o} ) = {\int }_{{Λ}^{Γ}} ( {{x}^{->}}_{o} ) ⅆ λ \frac{1}{‖ {{x}^{->}}_{0} - {Γ}_{λ} ( {a}^{->} ( λ ) ) ‖} {g}_{F λ} ( λ , {A}_{λ}^{T} {n}^{*} )$$
where \vec{n}* designates a unitary vector orthogonal to a radius linking the point P in question to the source S in the illustration of FIG. 2, and where g_{Fλ} is given in the following formula (8)

$$\begin{matrix}{g}_{F λ} ( β , {A}_{β}^{T} n ) = \frac{\partial }{\partial β} \{ \vert det {A}_{β} \vert {g}_{H β} ( β , {A}_{β}^{T} {n}^{->} ) \} \\ = \frac{\partial }{\partial β} \{ \frac{\vert det {A}_{β} \vert}{‖ {A}_{β}^{T} {n}^{->} ‖} {g}_{H β} ( ( β , \frac{{A}_{β}^{T} {n}^{->}}{‖ {A}_{β}^{T} {n}^{->} ‖} ) ) \}\end{matrix}$$

The specialist could use a method of difference finished on two or three points to create this derivation step.

This derivation is performed according to the parameter λ of the trajectory of the focal point (source S). It is specifically adapted to the improved deformation and mobility model as it applies to a direction A_{β}^{T}\vec{n} by considering that the direction \vec{n} is kept constant. So it is not the direction orthogonal to an acquired radius, but the direction orthogonal to the equivalent radius of the artificial geometry, which is to be kept constant.

A_{β}^{T}\vec{n} is the direction orthogonal to the projection straight at the instant λ passing through the mobile point corresponding to point P.

This inversion formula takes deformations of the object E into consideration and comprises, relative to other formulas, set in ordinary cases, a weighting as a function of the deformation of the object (by the determinant of Aλ) and of the position of the trajectory (by the standard between \vec{x}₀ and Γλ(\vec{α}(λ)). These barely constrained conditions are explained by an improved space of transformation, the projection straight lines of FIG. 1 remain straight lines in the artificial geometry of FIG. 2, such that the numerical problem can be resolved analytically.

In formula (7)

$${f}_{o} ( {{x}^{->}}_{o} ) = {\int }_{{Λ}^{Γ}} ( {{x}^{->}}_{o} ) ⅆ λ \frac{1}{‖ {{x}^{->}}_{0} - {Γ}_{λ} ( {a}^{->} ( λ ) ) ‖} {g}_{F λ} ( λ , {A}_{λ}^{T} {n}^{*} )$$

the limits of the integral Λ^{Γ}(\vec{x}₀) designate a minimal set of positions λ of the source S, such that on the object E in the reference state the directions of the straight lines linking \vec{x}₀ to Γλ(\vec{α}(λ)) cover the entire interval of a semi-turn of trajectory without redundancy. If care is taken to thus limit the integral, the reconstruction formula is perfect. The integral of formula (7) could be classically made discrete by the specialist by a formula of trapezes.

It is shown that the improved deformations do not sufficiently model all the objects which have to be studied in practice. FIGS. 3a, 3b, 3c, and 4 are offered as a revision of the reasoning of FIGS. 1 and 2. The object E evolves in complex fashion between the positions indicated successively in states λ1, λ2 and λ3 or the position of the source S was also indicated along with the radius R1, R2 or R3 leading to point P.

In returning the object E to a reference state, FIG. 4 shows that the radii designated R′1, R′2 and R′3 leading to point P and corresponding to radii R1, R2 and R3 (passing through the same points of the object E) are no longer rectilinear. The formula (7)

$${f}_{o} ( {{x}^{->}}_{o} ) = {\int }_{{Λ}^{Γ}} ( {{x}^{->}}_{o} ) ⅆ λ \frac{1}{‖ {{x}^{->}}_{0} - {Γ}_{λ} ( {a}^{->} ( λ ) ) ‖} {g}_{F λ} ( λ , {A}_{λ}^{T} {n}^{*} )$$

is thus no longer directly acceptable. However, it is approached by approximations, supposing improved deformation of the object E particular to each point P and valid around it. The deformation matrix corresponding to A_{λ}, of the formula (1)

$${{x}^{->}}_{0} = {Γ}_{λ} ( {x}^{->} ) = {A}_{λ} {x}^{->} + {B}_{λ} = [ \frac{{a}_{11} ( λ ) {a}_{12} ( λ )}{{a}_{21} ( λ ) {a}_{22} ( λ )} ] {x}^{->} + [ \frac{{b}_{1} ( λ )}{{b}_{2} ( λ )} ] \qquad ( 1 )$$

is thus calculated by the formula (9)

$${A}_{β} ( {Γ}^{- 1} ( {{x}^{->}}_{0} ) ) = [ \frac{\frac{\partial }{\partial {x}_{1}} ( {Γ}_{x1} ( β , {Γ}^{- 1} ( {{x}^{->}}_{0} ) ) \frac{\partial }{\partial {x}_{2}} {Γ}_{x1} ( β , {Γ}_{- 1} ( {{x}^{->}}_{0} ) )}{\frac{\partial }{\partial x1} {Γ}_{x2} ( β , {Γ}^{- 1} ( {x}_{0} ) ) \frac{\partial }{\partial x2} {Γ}_{x2} ( β , {Γ}^{- 1} ( {{x}^{->}}_{0} ) )} ]$$

where Γₓ₁(λ,\vec{x}) and Γₓ₂(λ,\vec{x}) are the compounds according to the main directions x₁ and x₂ of Γ(λ,\vec{x}). B_{λ} does not need to be calculated. The estimated shifts of all the points of the object E are thus the coefficients Γ(λ,\vec{x}) which can concretely be introduced to shift cards which are read and executed at the moment of inversion.

At each point P, it will still be necessary to determine the set of projections Λ^{Γ}(\vec{x}₀) which will be used for inversion, according to the abovementioned principle that an angular interval of a semi-turn must be covered by these projections. As the radii of the artificial geometry R′1, R′2 and R′3, etc. are no longer rectilinear, the directions of their tangent to the point P of intersection are considered.

The inversion formula can thus be written according to the formula (10)

$${f}_{0} \approx {\int }_{{Λ}^{Γ} \text{(} {{x}^{->}}_{0} \text{)}} ⅆ λ \frac{1}{L \text{(} {x}^{->} 0 - {Γ}_{λ} \text{(} {a}^{->} ( λ ) \text{)}} {g}_{F λ} \text{(} λ , {n}^{->} \text{(} \text{(} {Γ}^{- 1} \text{(} {x}^{->} 0 \text{)} , λ \text{)} \text{)} ,$$

where g_{Fλ} is expressed by the formula (11)

$${g}_{F λ} \text{(} λ , {n}^{->} \text{(} {Γ}^{- 1} \text{(} {{x}^{->}}_{0} \text{)} , λ \text{)} \text{)} = \frac{\partial }{\partial λ} \{ \vert \frac{det {A}_{λ} \text{(} {Γ}^{- 1} \text{(} {{x}^{->}}_{0} \text{)} \text{)}}{β \text{(} {n}^{->} \text{(} {Γ}^{- 1} \text{(} {{x}^{->}}_{0} \text{)} , λ \text{)} \text{)}} \vert \} {g}_{H λ} \text{(} λ , n \text{(} {Γ}^{- 1} \text{(} {{x}^{->}}_{0} \text{)} , λ \text{)} \text{)}$$

In addition, \vec{n}(Γ⁻¹(\vec{x}₀), λ) is the direction orthogonal to the straight line acquired at the instant λ passing through Γ⁻¹(\vec{x}₀); β(\vec{n}(Γ⁻¹(Γ⁻¹)\vec{x}₀),λ)) is a factor associated with deformation of the lengths on the radii, according to the formula (12)

$$β \text{(} {n}^{->} \text{(} {Γ}^{- 1} \text{(} {{x}^{->}}_{0} \text{)} , β \text{)} \text{)} = ‖ {A}_{β}^{T} \text{(} {Γ}^{- 1} \text{(} {{x}^{->}}_{0} \text{)} \text{)} ( \frac{{A}_{β}^{- T} \text{(} {Γ}^{- 1} \text{(} {{x}^{->}}_{0} \text{)} \text{)} {n}^{->} \text{(} {Γ}^{- 1} \text{(} {{x}^{->}}_{0} \text{)} , β \text{)}}{‖ {A}_{β}^{- T} \text{(} {Γ}^{- 1} \text{(} {{x}^{->}}_{0} \text{)} \text{)} {n}^{->} \text{(} {Γ}^{- 1} \text{(} {{x}^{->}}_{0} \text{)} , β \text{)} ‖} ) ‖ .$$

Finally, L(\vec{x}₀−Γ_{λ}(\vec{α}(λ)) is the distance from point P to the image of the source on the reference object, along the virtual radius R′.

To the detriment of quality, but in the interests of greater simplicity, the term L(\vec{x}₀−Γ_{λ}(\vec{a}(λ)) can be replaced by ∥\vec{x}₀−r_{λ}(\vec{α}(λ))∥and the term

$$\vert \frac{det {A}_{λ} \text{(} {Γ}^{- 1} \text{(} {{x}^{->}}_{0} \text{)} \text{)}}{β \text{(} {m}^{->} \text{(} {Γ}^{- 1} \text{(} {{x}^{->}}_{0} \text{)} , λ \text{)}} \vert$$

by 1.

The improved model can be defined according to the real deformation of the object by an approximation according to an approximation criterion such as the criterion of lesser squares, the criterion of minimisation of the L¹ and L² standard, optionally complete by regularising on the gradient or the Laplacian.

To date interest has been shown in reconstructions of the object E by slices, in fan-shaped parallel conditions. The preceding process can be extended with acquisitions by conical radiation under the conventional conditions of FIG. 5, or the object E is represented in its three-dimensional entirety, also as for the network of detectors D, which is composed of a series of layers of detectors, each similar to that of the preceding figures; a radius R can be expressed by three parameters, namely the position λ of the source S, an angle γ which makes the radius R in the plane of the trajectory T relative to the central axis X of the bundle, and a cote q marking the layer of detectors in which the radius terminates. The angle γ replaces the direction vector \vec{a} previously used in the formulas out of convenience.

The following formula (13)

$${f}_{0}^{\#} \text{(} {{x}^{->}}_{0} \text{)} = {\int }_{{Λ}^{Γ} \text{(} {{x}^{->}}_{0} \text{)}} ⅆ λ \frac{1}{L \text{(} {{x}^{->}}_{0} - {Γ}_{λ} ( a ( λ ) )} {g}_{F λ} \text{(} λ , n \text{(} {Γ}^{- 1} \text{(} {{x}^{->}}_{0} \text{)} , λ \text{)} , q \text{(} λ , {Γ}_{z}^{- 1} {{x}^{->}}_{0} \text{)} \text{)}$$

gives the inversion which is undertaken in these particular geometric conditions and by making a Feldkamp approximation commonly used for treating the conical projections. The measurements are in this case multiplied by cos A, which is classic weighting compensating the oblique character of the acquired radius. This angle A is given in FIG. 5 and illustrates the angle of the radius R with the plane of the trajectory T. In addition, L(\vec{x}₀−Γλ(\vec{a}(\vec{λ}))) is the distance from \vec{x} to the image of the source S on the object E in the reference state along the virtual radius R′, in projection on the plan of the trajectory T, and \vec{n}(Γ⁻¹(x0),λ) is the direction orthogonal to the straight line acquired at the instant X passing through Γ⁻¹(\vec{x0}) on this plane. Finally, it is apparent that q(λ,Γ_{z}⁻¹(xₒ)) is the side on the network of detectors D of the straight line, acquired at the instant λ, passing through the mobile point corresponding to \vec{x0}.

A particular process, first described in French patent 01 07918 filed under number can still be applied here by way of some transformations. This process applies to rapid acquisitions made around the object by making several turns and consists of a reconstruction of the animated object by evaluating its contents by blocks of projections taken on a fraction of a turn only of the source. The inversions of projections made on the blocks produce sub-images which are incorrect since they comprise only part of the measurements, but are obtained very rapidly and with the same rapidity create the law of displacement or deformation of the object by comparing homologous sub-images, taken for the same positions of spaced sources of a complete turn or a semi-turn; the sub-images are reconstructed at a reference instant for each of the groups of blocks and finally combined to give the complete image of the object. Here, the limits of the blocks are given in virtual geometry. The process is not otherwise modified.

Finally, it is possible to improve the process to study an object subjected to periodical phenomena. Only those which are taken at phases of the phenomenon similar to those of the reference instant are selected as study blocks.

Reference can be made to the organigrams of FIGS. 6, 7 and 8 to understand the invention. They detail three embodiments of the invention, or reconstruction is done respectively with compensation of movement; compensation of movement and time compensation; and compensation of movement, time compensation and consideration of periodicity of the evolution of the object. What has been previously described is applied in these processes. The voxels are evidently the points of the image of the object considered in the reconstructed image.

1. A process for reconstruction of a tomographic image of an especially mobile and deformable object, the image being a set of values of a property taken by points of the object, comprising the use of: divergent radiation from a focal point and passing through the object, the focal point being mobile about the object; an analytical model of mobility and deformation of the object defined for each position of the focal point; and an analytical calculation process for obtaining said values from totals of the values of the property along projection lines leading to the focal point and passing respectively by the points; characterised in that the model is improved, and is a variable combination being acquired, this combination comprising translations, rotations and homotheties of the object from an origin, and in that the process of analytical calculation comprises the following stages:
weighting of the measurements, this weighting being dependent on the analytical model of mobility and deformation of the object;
derivation of the measurements weighted following the trajectory of the focal point considering a direction adapted to the model, this direction being kept constant, and obtaining modified measurements;
retroprojection of the modified measurements.

2. The process for reconstruction of an image as claimed in claim 1, characterised in that it comprises a step of integration interval definition giving f₀(\vec{x₀}) such that the projection lines have directions extending over an interval of N semi-turns considered in a state of the object where the image is reconstructed, N being greater than or equal to 1.

3. The process for reconstruction of an image as claimed in claim 1, characterised in that it is applied with a particular analytical mobility and deformation model at each point of the object.

4. The process for reconstruction of an image as claimed in claim 3, characterised in that the improved linear part of the particular analytical model corresponds to the improved local approximation of a family of trajectories passing through points located in the region of each point.

5. The process for reconstruction of an image as claimed in claim 2, characterised in that the directions of the projection lines are considered at the point of the object where the process is applied.

6. The process for reconstruction of an image as claimed in claim 1, characterised in that reconstruction is carried out first by sub-images constructed with projection lines having directions in the angular intervals smaller than a semi-turn, in that it comprises a stage of determining the angular intervals to which the projection lines belong, and in that it comprises a stage of combining the sub-images after correction of the general law of evolution of the object between the positions associated with different reference instants associated with each angular interval.

7. The process for reconstruction of an image as in claim 1, characterised in that the general law of evolution of the object is periodical and in that the reference instants are selected for the same phase of periods of movement of the object.

8. The process for reconstruction of an image as in claim 1, where radiation is conical, characterised in that prior to the step of filtering the acquired measurements, the process comprises a stage of weighting the acquired measurements adapted to acquisition of the measurements in conical geometry and in that the retroprojection is performed according to the conical geometry by taking into consideration the analytical model of mobility and deformation of the object.

9. The process for reconstruction of an image as in claim 1, characterised in that weighting of the measurements is preceded by filtering the measurements acquired by a Hilbert filter.

10. The process for reconstruction of an image as in claim 1, characterised in that the improved model is obtained by approximation of real deformations of the object according to an approximation criterion.
